(19) United States
(12) Patent Application Publication
(10) Pub. No.: US 2025/0200465 A1
(43) Pub. Date: Jun. 19, 2025

(54) Utilization-Based Feedback Control for Schedule Generation

(71) Applicant: ZEBRA TECHNOLOGIES CORPORATION, Lincolnshire, IL (US)

(72) Inventors: Niwedita Dubey, Raleigh, NC (US); Hareesh Babu Annu, Mansfield, MA (US); Sriram Krishnan, Sharon, MA (US); Arun Santhanam, Medfield, MA (US)

(21) Appl. No.: 18/543,042

(22) Filed: Dec. 18, 2023

(51) Int. Cl. G06Q 10/0631

(52) U.S. Cl. CPC G06Q 10/063116

(57) ABSTRACT

A method includes: retrieving, at a computing device, a plurality of target profiles, each target profile including a target identifier and a reference value for a target attribute; generating, at the computing device, based on the target profiles, a first schedule including a first plurality of shift records, each shift record of the first plurality including one of the target identifiers; determining, at the computing device, a utilization metric for each target identifier based on the first schedule; generating, at the computing device, a modified target profile corresponding to one of the target identifiers selected based on the utilization metrics, the modified target profile including a modified value for the target attribute; and generating, at the computing device, a second schedule based on the modified target profile.

### BACKGROUND

The generation of scheduling data, such as a set of shifts for distribution to employees in a retail facility or the like, can be a complex multi-variate process. Computer-generated scheduling data may fail to meet expected capacity targets, under some conditions. Further, certain factors may be omitted from consideration in computer-generated scheduling data, as accounting for such factors may introduce excessive computational complexity.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for utilization-based feedback control for schedule generation.

FIG. 2 is a flowchart of a method of utilization-based feedback control for schedule generation.

FIG. 3 is a diagram illustrating an example performance of block 205 of the method of FIG. 2.

FIG. 4 is a diagram illustrating an example performance of blocks 210 and 215 of the method of FIG. 2.

FIG. 5 is a diagram illustrating an example performance of block 220 of the method of FIG. 2.

FIG. 6 is a diagram illustrating an example performance of block 235 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, including: retrieving, at a computing device, a plurality of target profiles, each target profile including a target identifier and a reference value for a target attribute; generating, at the computing device, based on the plurality of target profiles, a first schedule including a first plurality of shift records, each shift record of the first plurality of shift records including one of the target identifiers; determining, at the computing device, a utilization metric for each target identifier based on the first schedule; generating, at the computing device, a modified target profile corresponding to one of the target identifiers selected based on the utilization metrics, the modified target profile including a modified value for the target attribute; and generating, at the computing device, a second schedule based on the modified target profile.

Additional examples disclosed herein are directed to a computing device, comprising: a memory; and a processor configured to: retrieve a plurality of target profiles, each target profile including a target identifier and a reference value for a target attribute; generate based on the plurality of target profiles, a first schedule including a first plurality of shift records, each shift record of the first plurality of shift records including one of the target identifiers; determine a utilization metric for each target identifier based on the first schedule; generate a modified target profile corresponding to one of the target identifiers selected based on the utilization metrics, the modified target profile including a modified value for the target attribute; and generate a second schedule based on the modified target profile.

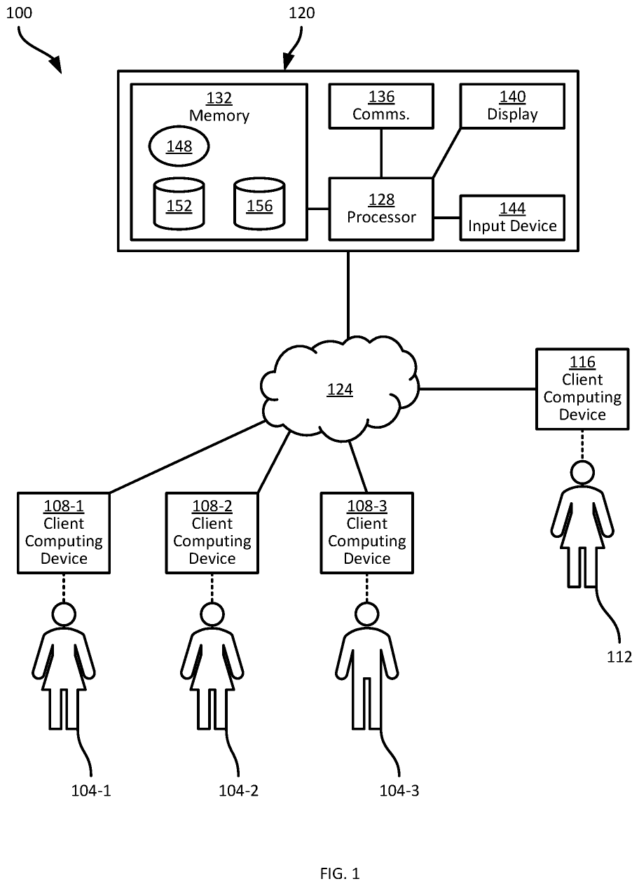

FIG. 1 illustrates a system 100 for utilization-based feedback control of schedule-generation mechanisms. The system 100 can be deployed in association with one or more retail facilities, manufacturing facilities, healthcare facilities, or the like, to deploy scheduling data to a plurality of employees in the facility. Three example employees 104-1, 104-2, and 104-3 are shown in FIG. 1, although it will be understood that the system 100 can deploy scheduling data to a greater number of employees than those shown. The employees 104-1, 104-2, and 104-3 may also be referred to below collectively as the employees 104, and any given employee may be referred to generically as an employee 104. Similar nomenclature is used elsewhere herein for reference numbers with hyphenated suffixes.

Deploying scheduling data to the employees 104 includes providing at least some of the employees 104 (e.g., as few as one of the employees 104, and as many as all of the employees 104) with data defining which periods of time those employees are scheduled to work at the facility. Each such period is referred to as a shift. The data defining a given shift can also define a wide variety of other information, including which task(s) are assigned to an employee during the shift, which locations an employee 104 is assigned to for a given shift (e.g., departments in a facility, one of a plurality of facilities with different geographic locations, or the like), for example if the system 100 manages scheduling for more than one physical facility, and the like. The schedule-generation mechanisms described herein can be used in a planning process to select inputs for subsequent schedule data generation, in addition to or instead of being used for generating schedules for actual deployment and implementation.

The complexity of generating scheduling data can increase with the number of employees 104, the size of the facility (e.g., greater labor demands at larger facilities may involve assigning concurrent shifts to larger numbers of employees), the variety of tasks to be performed, and the like. Various systems therefore implement automated schedule generation mechanisms. Such systems consume a variety of inputs corresponding to the employees 104, such as employee type (e.g., full-time or part-time), employee skills and/or certifications, planned employee availability and absences, roles, work locations, and the like. Such systems also consume inputs associated with the facility, such as definitions of labor demand over a planning period. For example, the labor demand can be defined as a number of hours for each of a plurality of tasks to be performed in the facility, for each day (or other suitable period) over a planning period, such as one week. By processing those inputs, automated schedule generation systems seek to generate a set of shifts assigned to at least a portion of the employees 104 over the planning period, optimized according to a variety of factors. Examples of those factors include fulfilling the defined labor demand, reducing or avoiding unassigned time during shifts (e.g., time during which no task is assigned to an employee), and avoiding conflicts with labor laws and scheduling rules (e.g., maximum permitted consecutive working hours, minimum break lengths between shifts, and the like).

A schedule generated by such an automated schedule generation system can be deployed to the employees 104 by, for example, transmitting shift definitions to the employees 104 to whom those shifts are assigned. For example, each employee 104 can operate a respective client computing device 108-1, 108-2, 108-3, such as a smartphone, a tablet computer, or the like. Shifts can be transmitted to the client devices 108 for viewing by the relevant employees via a web browser, a dedicated scheduling application, or the like. The automatically generated schedule can also be provided to an administrator 112, such as a manager of the facility (the facility may have more than one manager in some examples), via a client computing device 116 operated by the administrator 112. The administrator 112 and the employees 104 may, for example, have account credentials or the like permitting access to a web-based application where schedule data can be viewed and/or edited.

The provision of a schedule to either or both of the employees 104 and the administrator 112 via the client devices 108 and 116 is generally followed by implementation of the schedule by the employees 104 and/or the administrator 112. For example, each employee 104 can attend at the location defined in a given shift record (e.g., a collection of data defining various attributes of the shift), at the time defined in that shift record, to perform the task(s) identified in that shift record.

Prior to generating schedule data for deployment to the employees 104 for implementation, previous systems may perform a planning process to determine certain inputs for schedule generation, such as a number of employees for use in schedule generation. Although labor demand can be consumed as an input to the planning process in previous systems, the labor demand may be consumed in a simplified form to mitigate the computational complexity of the planning process. For example, certain tasks may have varying demand over the course of a given day. For instance, at a retail facility, there may be greater demand for cashiers between 4 pm and 6 pm on weekdays than during the remainder of those days. However, inputs to previous planning processes may specify only a total expected number of person-hours of cashiering to fulfill for each day, or for the entire planning period (e.g., one week). In other words, although intraday demand variations may be observed and in some cases documented, previous systems may be unable to account for those variations during automated planning. Peak demand periods used in automated planning to select inputs for schedule generation, as mentioned above, may indicate certain intraday periods when customer traffic is expected to be highest, but are generally not task-specific, and also do not provide specific labor demand targets, e.g., in person-hours, during those intraday periods.

As a result of approximations or omissions in input data provided to planning processes, prior systems may generate schedules that do not meet certain intraday demand variations, particularly when the total available capacity from the employees 104 is close to or below the total labor demand. As a result, an administrator 112 may adjust a schedule substantially in real-time in an effort to address intraday variations. Such adjustments can include reassigning an employee 104 to another department, transferring an employee 104 to or from another location, extending employee shifts, or the like. The ad-hoc, manually-generated nature of the above adjustments can lead to errors that reduce coverage of intraday demand variations, and/or can make inefficient use of employee time (e.g., repeatedly transferring employees 104 between locations).

The system 100, as described below, implements certain functionality to enable the automated assessment of factors that previous systems are unable to assess automatically, while mitigating the increase in computational complexity arising from such assessment. The system 100 permits, for example, automated assessments of employee utilization in a generated schedule and/or of how effectively a schedule satisfies intraday labor demand. The outcome of those assessments can be used to implement a feedback mechanism, generating further schedule data without introducing additional complexity to the schedule generation process itself.

The system 100 includes a computing device 120, such as a server, distributed computing device, or the like, in communication with the client devices 108 and 116 via a network 124 (e.g., a suitable combination of local and wide area networks). The device 120 is configured to generate schedules, automatically assess certain aspects of the generated schedules, and generate modified schedules based on the results of those assessments.

The device 120 includes a processor 128 (e.g., a central processing unit (CPU), graphics processing unit (GPU), and/or other suitable control circuitry, microcontroller, or the like), interconnected with a non-transitory computer readable storage medium, such as a memory 132. The memory 132 includes a suitable combination of volatile memory (e.g. Random Access Memory or RAM) and non-volatile memory (e.g. read only memory or ROM, Electrically Erasable Programmable Read Only Memory or EEPROM, flash memory). The memory 132 stores computer-readable instructions, execution of which by the processor 128 configures the processor 128 to perform various functions in conjunction with certain other components of the computing device 120. The computing device 120 also includes a communications interface 136 enabling the device 120 to exchange data with other computing devices such as the client devices 108 and 116, e.g., via the network 124. The device 120 can also include a display 140 and/or other suitable output device. The device 120 can further include an input device 144 such as a keyboard, a mouse, a touch panel or the like.

The instructions stored in the memory 132 include, in this example, a schedule feedback application 148 that, when executed by the processor 128, configures the device 120 to assess a schedule and trigger the generation of an updated schedule based on the assessment. The functionality implemented by the application 148 can be integrated with a schedule generation application executed by the device 120, in some examples. The device 120 and the application 148 may be referred to in the discussion below as being configured to perform various actions. It will be understood that such references indicate that the device 120 is configured to perform those actions via execution of the application 148 by the processor 128. In some examples, the application 148 can be implemented via a suite of distinct applications, and/or via dedicated control hardware, such as an application-specific integrated circuit (ASIC) or the like.

The memory 132 can also store a repository 152, containing profile data corresponding to the employees 104 and/or the facility (e.g., labor laws, labor demand for the facility, employee profile data such as vacation and/or other absences, skills and certifications, full-time or part-time type indicators, employee availability, roles, locations, and the like). The memory 132 can also store, in some examples, a repository 156 of schedule data, e.g., one or more sets of shift records, each set representing a schedule generated for a given facility and a given planning period.

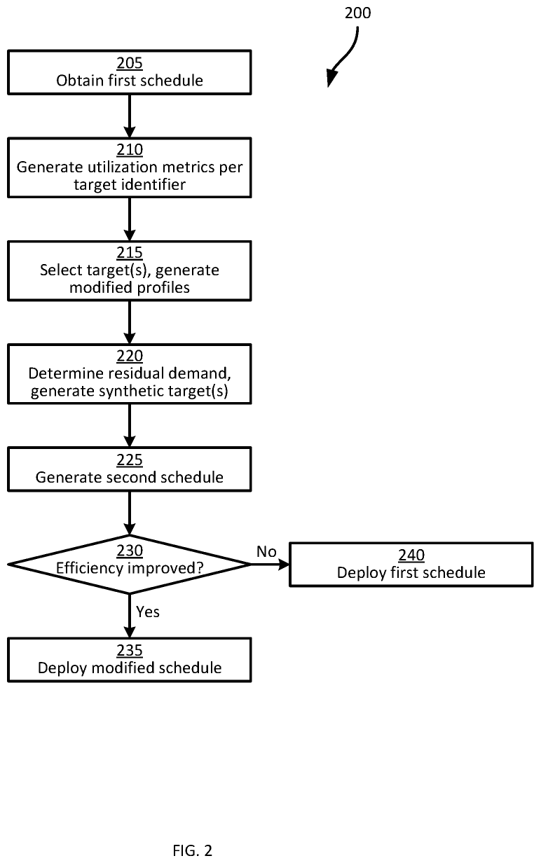

Turning to FIG. 2, a method 200 of utilization-based feedback control for schedule generation is illustrated. The method 200 is described below in conjunction with its performance by the device 120, via execution of the application 148 by the processor 128.

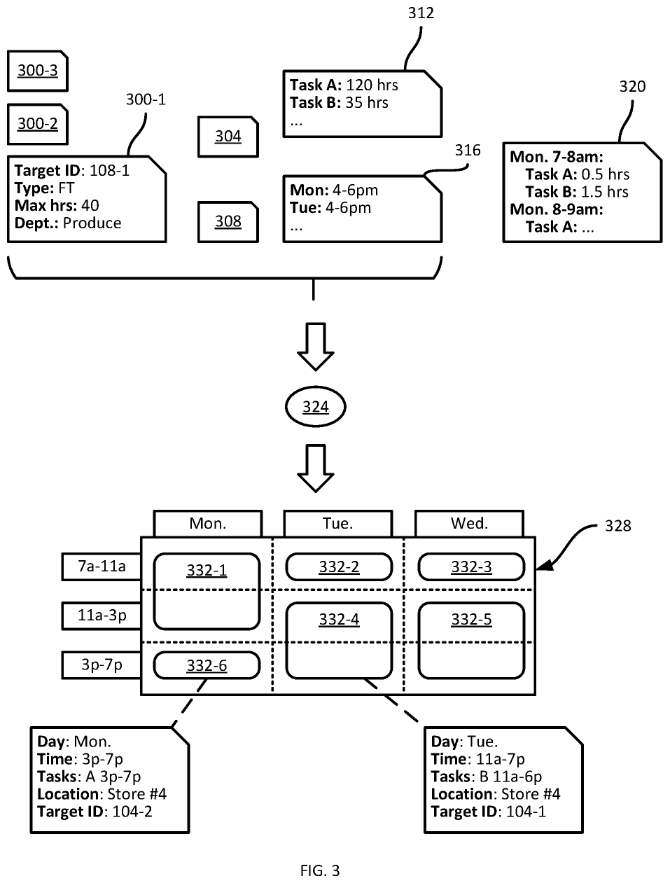

At block 205, the device 120 is configured to obtain a first schedule. The device 120 can obtain the first schedule by generating the first schedule, or by retrieving the first schedule from the repository 156, e.g., after generation of the first schedule by another computing device. The first schedule includes a plurality of shift records, each including a target identifier corresponding to one of the employees 104. The generation of shift records at block 205 can be performed according to any suitable shift generation mechanism. FIG. 3 illustrates an example shift generation process. In the example illustrated in FIG. 3, as will be understood by those skilled in the art, inputs to shift generation can include employee profile data, e.g., retrieved from the repository 152. Example employee profiles, or target profiles 300-1, 300-2, and 300-3 are shown in FIG. 3, corresponding respectively to the employees 104-1, 104-2, and 104-3. Each employee profile 300 includes a target identifier, e.g., matching the reference numbers introduced in FIG. 1 in this example. In other examples, target identifiers can include names, account identifiers of the employees 104, or the like. Each profile 300 also includes one or more attributes, with a reference value for each attribute. A profile 300 can include a wide variety of attributes, including for example an employee type (e.g., with reference values selected from “FT” for full-time and “PT” for part-time) and a maximum weekly work hours cap (e.g., with numerical reference values). Other attributes included in the profiles 300 can include department identifiers, job roles, location identifiers, skills and/or certifications, seniority indicators, availability (e.g., the days of the week and/or times a given employee 104 is regularly available for work), and the like.

The inputs to the schedule generation operation can also include labor laws 304, calendar data 308 (e.g., defining vacations or other absences), as well as labor demand. Labor demand data provided to the schedule generation operation can include, as shown in FIG. 3, one or more records 312 defining a number of person-hours or other suitable measurement of demand for each of a plurality of tasks, roles or the like in the facility, over the period for which a schedule is to be generated (e.g., one week). The inputs can also include one or more records 316 defining peak intraday demand periods, e.g., as time periods for each weekday when maximum customer traffic in the facility is expected, or the like.

The repository 152 can also contain labor demand data at a more granular level than the record 312. For example, FIG. 3 illustrates granular labor demand data 320 that defines, for each interval, labor demand for each of a plurality of tasks or roles as a number of person-hours. In other words, the granular labor demand data 320 can define a number of person-hours for a task “A” and a task “B” for the interval between 7 am and 8 am on Monday, as well as the number of person hours for those tasks for the next one-hour interval, and so on throughout the planning period (e.g., each one-hour period for one week). Other time intervals can be defined in the data 320, such as fifteen-minute periods, four-hour periods, or the like. As will be understood, although the total person-hours for each task as defined in the data 320 may be equal to the amounts indicated in the labor demand 312, the data 320 may indicate intraday variations in labor demand more precisely than both the labor demand 312 and the peak intraday periods 316. The data 320, however, may be computationally costly to process via the schedule-generation operation, and is therefore omitted from block 205 and instead used in the feedback process discussed further below.

Having retrieved the input data described above, the device 120, or another computing device executing a schedule generator 324, can be configured to sort each target identifier according to values from the employee profiles 300, e.g., according to seniority, type (e.g., full-time or part-time) and the like. Beginning with the top-sorted target identifier, the device 120 can be configured to generate a plurality of shift candidates (e.g., all possible shift candidates that comply with the labor laws 304, calendar 308 and/or other constraints defined in the input data, such as meal break rules, shift length policies, and the like). The device 120 is further configured to assign one or more tasks from the labor demand 312 to each shift candidate.

The device 120 is then configured to determine a metric, such as a cost, for each shift candidate. The cost can be determined by summing rewards and penalties based on various predetermined conditions. Examples of reward conditions include satisfying demand for tasks, meeting minimum coverage requirements defined in the labor demand, covering peak demand hours, and the like. Examples of penalty conditions include portions of a shift candidate that do not have assigned tasks (e.g., idle time during a shift candidate), transitions between tasks occurring during a shift candidate (e.g., instead of a shift candidate being fully covered by a single task), and the like. The device 120 can then be configured, for each day in the planning period, to assign the lowest-cost candidate for that day to the relevant employee 104. Repeating the above process for each other employee in the sorted order noted above, until the labor demand 312 is met or no employees 104 remain to be processed, yields a first schedule 328.

The schedule 328 shown in FIG. 3 divides each of three weekdays into three four-hour segments (e.g., 7 am to 11 am, 11 am to 3 pm, and 3 pm to 7 pm). The specific weekdays and segments shown are for illustrative purposes only, and it will be understood that a wide variety of other schedule structures can also be employed. The schedule 328 includes a plurality of shift records 332-1, 332-2, 332-3, 332-4, 332-5, and 332-6, each covering a portion of a corresponding weekday. For example, the shift record 332-1 extends from 7 am to 3 pm on Monday. The schedule 328 can include multiple shift records for the same time period in other examples (e.g., representing shifts assigned to different employees 104 at the same time or for overlapping time periods). For example, more than one shift record 332 can exist for the time period covered by the shift record 332-1, e.g., if meeting labor demand at the facility involves having more than one employee on duty at that time.

Each shift record 332 can include a variety of attributes, such as a time period defined by shift start and end times, and one or more task identifiers corresponding to tasks assigned to the shift. The task identifiers can also be associated with time periods covering at least a portion of the shift record 332. Example contents of the shift records 332-4 and 332-6 are shown in FIG. 3, indicating that the shift record 332-4 has a total length of eight hours, and the task “B” assigned to seven of those eight hours (e.g., with one hour of idle time). The shift record 332-6 has a total length of four hours, and the task “A” assigned to all four hours. The shift records 332 can also include location indicators (e.g., identifying a facility such as the “Store #4” shown in FIG. 3, a department within a facility, or both). The shift records 332 can also include various other attributes, including target identifiers that indicate which employee 104 is assigned to a shift. As seen in FIG. 3, the shift record 332-4 is assigned to the employee 104-1, and the shift record 332-6 is assigned to the employee 104-2.

Returning to FIG. 2, in response to generating or otherwise obtaining the first schedule 328 at block 205, rather than deploying the first schedule 328, the device 120 is configured, at block 210, to determine a utilization metric for each employee 104. Each employee 104, e.g., as shown in the profile 300-1, can have an attribute defining a maximum number of working hours per week or other suitable period. The utilization metric is a measure of what portion of the number of working hours for the employee 104 are allocated by the schedule 328, and can also indicate how efficiently those hours are allocated.

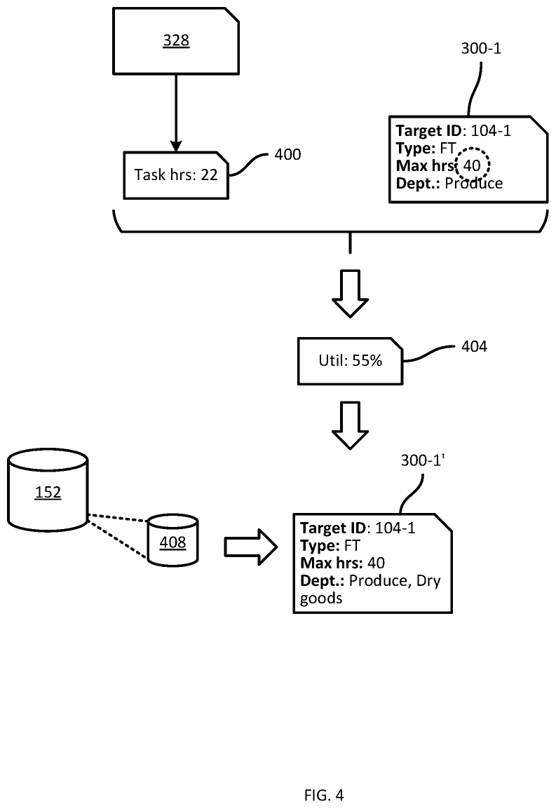

Turning to FIG. 4, an example performance of block 210 for the employee 104-1 is shown. To generate a utilization metric for the employee 104-1, the device 120 can be configured to retrieve, from the first schedule 328, each shift 332 assigned to the employee 104-1, and to determine a total 400 of hours assigned to the employee 104-1. In this example, the total 400 represents hours with tasks assigned, rather than the total length of all shifts for the employee 104-1 in the first schedule 328. For example, the shift record 332-4 contributes seven hours to the total 400 (which indicates a total of twenty-two hours), despite having a total length of eight hours, because only seven of the hours represented by the shift record 332-4 are assigned to a task.

The device 120 can also retrieve the maximum working hours from the profile 300-1, and determine a utilization metric 404 in the form of a ratio of the total 400 to the maximum (e.g., expressed as a percentage in this example, although a wide variety of other formats can be used for the utilization metric 404). As will be understood, an employee 104 assigned to shifts summing to their maximum working hours may still have a relatively low utilization metric 404 if many of the assigned shifts include idle time not assigned to tasks.

Returning to FIG. 2, at block 215 the device 120 is configured to select a subset of target identifiers based on the utilization metrics from block 210. The subset selected at block 215 can include as few as zero of the employees 104, and as many as all of the employees 104. The device 120 can be configured to select any employee 104 with a utilization metric below a threshold (e.g., 60%, although a wide variety of other thresholds can be used). The employees 104 selected at block 215 are employees 104 that may be underutilized or inefficiently utilized by the first schedule 328, and therefore may represent opportunities to modify the first schedule 328 to increase the proportion of the intraday labor demand 320 satisfied, or the like.

The device 120 is also configured, at block 215, to generate modified profiles for the employees 104 selected based on the utilization metrics 404. For example, as shown in FIG. 4, the device 120 can retrieve configuration settings 408 or the like from the repository 152 that define modifications to make at block 215. The modifications at block 215 can include, for example, modifications to any one or more of a maximum number of hours for a part-time employee (e.g., increasing the maximum number of hours to a cap of thirty), the department the employee 104 is assigned to, as shown in FIG. 4, skills and/or certifications, availability, roles, locations, and the like. The configuration settings 408 can specify, for example, which attributes are to be modified, e.g., enabling the administrator 112 to disable modifications that may be difficult to implement in practice, such as skill or certification changes. The configuration data 408 can also define modified values for the attributes to be modified, and/or rules for modifying the reference values in the profile 300. For example, in the case of maximum working hours, the configuration data 408 can specify a modified value of thirty for any part-time employee, as noted above. In another example, the configuration data 408 can define a rule by which any departments not identified in a reference value of a profile 300 are to be added as a modified value to a modified version of the profile 300 (e.g., expanding the range of locations the employee 104 is eligible to work).

The profile 300 itself need not be modified at block 215. As shown in FIG. 4, the device 120 can generate a temporary modified profile 300-1′ corresponding to the profile 300-1, and can maintain both the profiles 300-1 and 300-1′, at least for the performance of the method 200. Following the performance of the method 200, the modified profile 300-1′ may be discarded, while the profile 300-1 is retained.

The performance of blocks 210 and 215 identifies certain employees 104 as being potentially inefficiently utilized by the schedule generation process of block 205. The identification of those employees 104, and the generation of modified versions of their profiles 300 at block 215, may permit the generation of a second schedule that makes more efficient use of the employees 104. Prior to generation of a second schedule, the device 120 can also identify a potential need for additional staff (e.g., beyond the employees 104 represented by profiles 300 in the repository 152) to satisfy labor demand unmet by the first schedule 328.

At block 220, the device 120 can be configured to compare the first schedule 328 to the granular labor demand data 320, and determine a residual demand, e.g., in a number of hours per task, per role, or the like. In some examples, block 220 can be performed in parallel with blocks 210 and 215, or prior to block 210, instead of after block 215 as shown in FIG. 2.

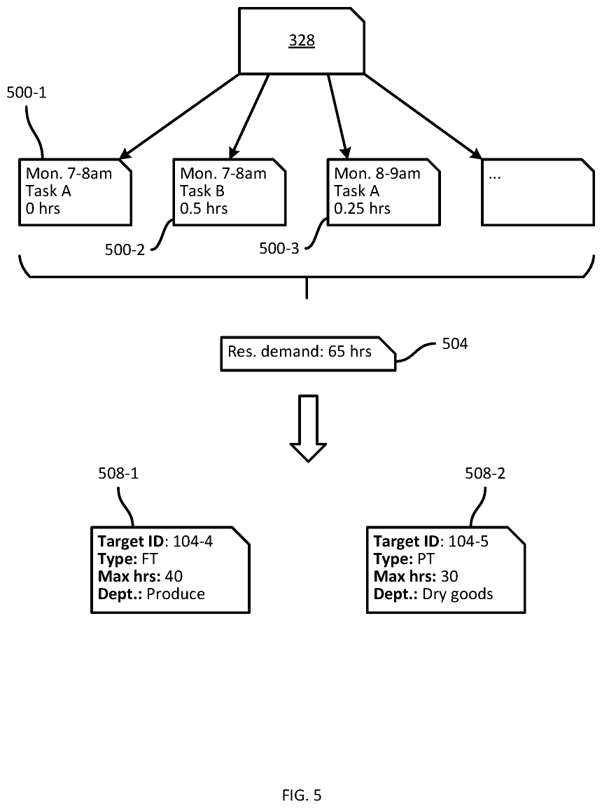

The determination of residual demand at block 220 includes, for each combination of a time period and a task defined in the data 320 (e.g., the hour from 7 am to 8 am on Monday, for the task “A”, as shown in FIG. 3), determining the total number of person hours assigned to the corresponding task during the corresponding time period in the schedule 328. The residual demand for that time period and that task is the difference (if any) between the number of person hours assigned in the schedule 328 and the demand defined in the data 320. For example, as shown in FIG. 5, the device 120 can determine residual demand components 500-1, 500-2, 500-3, and so on, for each pair of a time period and a task defined in the data 320. For example, the residual demand component 500-1 indicates that the labor demand for the task “A” in the time period between 7 am and 8 am on Monday (e.g., 0.5 hours as shown in FIG. 3) is fully met (e.g., a residual demand of zero) by the first schedule 328. The residual demand component 500-2 indicates that of the 1.5 hours of labor demand for the task “B” indicated in the data 320 for the time period of 7-8 am on Monday, one half-hour is not met by the first schedule 328.

The device 120 can be configured to combine the residual demand components 500 for every time period and task combination defined in the data 320, to generate a total residual demand 504 across all time periods and tasks. As shown in FIG. 5, the total residual demand in this example has a value of sixty-five hours. The total residual demand 504 indicates that during certain portions of the planning period covered by the first schedule 328, labor demand for some tasks may not be met, even in cases where the aggregate labor demand defined by the record 312 is met by the schedule 328.

Based on the residual demand 504, the device 120 can be configured to generate one or more synthetic employee profiles 508-1, 508-2. The synthetic profiles 508 do not correspond to actual employees 104, but can be used, as discussed below, as placeholders for employees transferred from other facilities or the like, to satisfy intraday peaks in demand. The synthetic profiles 508 can be populated with reference values for suitable attributes by, for example, selecting a profile 300 (e.g., at random from the profiles 300) and duplicating the reference values of the selected profile 300. Each synthetic profile can be assigned a new target identifier (rather than a duplicate of another target identifier), such as the identifiers 104-4 and 104-5 shown in FIG. 5. The synthetic profiles 508 can be stored temporarily, e.g., with the modified profile 300-1′.

As seen in FIG. 5, generating the synthetic profiles 508 can include retrieving a default maximum number of working hours for full-time and part-time employees 104, and selecting a combination of full-time and part-time synthetic profiles 508 that meets or exceeds the total residual demand 504. In some examples, the combination of full-time and part-time synthetic profiles 508 generated at block 220 can be constrained to match a ratio of full-time to part-time employees 104. For example, if 70% of the employees 104 are full-time and the remainder are part-time, the ratio of full-time to part-time synthetic profiles may be constrained to 70%.

At block 225, the device 120 is configured to generate a second schedule, using the mechanism set out above in connection with block 205. The input data used to generate the second schedule at block 225, however, includes modified profiles such as the profile 300-1′, instead of the original profile 300-1. The input data used at block 225 also includes the synthetic profiles 508 from block 220. In other words, while the performance of block 205 employs the profiles 300-1, 300-2, and 300-3, the performance of block 220 in this example employs the profile 300-1′, the profiles 300-2 and 300-3 (assuming that no modifications are made to the profiles 300-2 and 300-2 at block 215), as well as the profiles 508-1 and 508-2.

The input data used to generate the second schedule at block 225, in other words, defines additional resources, e.g., in the form of expanded employee 104 capabilities via modified profiles and/or synthetic profiles representing additional employees, relative to the input data used at block 205. The use of modified profiles such as the profile 300-1′ may reduce the search space for profile modifications via the utilization metric assessment at block 210 and permit the generation of schedule data that is more likely to satisfy intraday labor demand.

Further, the use of the synthetic profiles 508 for the second schedule generation at block 225 permits the device 120 to account for residual intraday demand based on the data 320, without the cost of incorporating granular labor demand earlier in the planning process. The use of synthetic profiles 508 may therefore improve the coverage of intraday demand, with little or no additional computational cost imposed on the device 120 to generate the second schedule in comparison with the computational cost of generating the first schedule 328.

At block 230, the device 120 can be configured, prior to deploying a schedule, to compare a coverage or total efficiency metric for the first schedule 328 and the second schedule from block 225. For example, the device 120 can determine what portion of a total number of hours represented by the labor demand 312 are covered by the first and second schedules. The coverage provided by each schedule represents the efficiency of that schedule. For example, if the first schedule has a coverage of 85%, and the second schedule has a coverage of 91%, the determination at block 230 is affirmative. When the determination at block 230 is affirmative, at block 235 the device 120 can be configured to deploy the second schedule from block 225, e.g., by presenting the schedule on the display 140, transmitting the schedule to the devices 108 and/or 116, or the like.

When the coverage provided by the first schedule is greater than the coverage provided by the second schedule, the device 120 is configured to proceed from block 230 to block 240, and deploy the first schedule instead of the second schedule. In some examples, the device 120 can omit the determination at block 230, and present both the first and second schedules to the administrator 112, e.g., for selection of a schedule to deploy. The device 120 can be configured to perform various optimizations on the schedules prior to deployment at block 235 or 240. For example, the device 120 can be configured to compare a schedule to one or more budgets, and to discard one or more shifts, e.g., if a monetary cost associated with the schedule exceeds a financial budget, and/or if a time cost (e.g., total scheduled hours) exceeds a time budget.

In some examples, the generation of a second schedule can be iterated. For example, in response to generating the second schedule, the device 120 can repeat the assessments and profile modifications at blocks 210-220 based on the second schedule, and generate a third schedule at block 225. In such implementations, the determination at block 230 compares the most recent schedule generated at block 225 (e.g., the third schedule) to the preceding schedule from block 225 (e.g., the second schedule). The determination at block 230 in such implementations can be a determination of whether to perform another iteration, e.g., if an improvement in efficiency for the most recent schedule exceeds a threshold, or to deploy the most recent schedule if the improvement in efficiency is below a threshold.

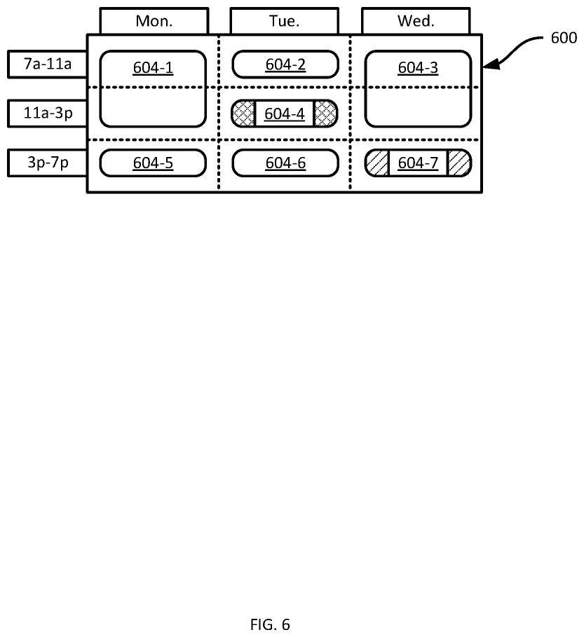

Turning to FIG. 6, an example second schedule 600 is illustrated, e.g., as presented on the display 140. The second schedule 600 includes a plurality of shifts 604-1, 604-2, 604-3, 604-4, 604-5, 604-6, and 604-7 is illustrated. Certain shifts, such as the shifts 604-4 and 604-7, can be presented with visual indicators to notify the administrator 112 that those shifts 604 are based on modified profile data (e.g., the modified profile 300-1′ or synthetic profiles 508), and may therefore require additional action to implement, such as initiating a transfer of employees from another location, or the like. The device 120 can, for example, present data indicating proposed staffing changes derived from the second schedule 600, such as a change to the number of employees 104 currently assigned to the facility, or the like. The device 120 may, for example, present a prompt for updated employee counts or other attributes (e.g., certifications or the like), and data received in response to such prompts can be used to generate a further schedule for deployment to the employees 104.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
retrieving, at a computing device, a plurality of target profiles, each target profile including a target identifier and a reference value for a target attribute;
generating, at the computing device, based on the plurality of target profiles, a first schedule including a first plurality of shift records, each shift record of the first plurality of shift records including one of the target identifiers;
determining, at the computing device, a utilization metric for each target identifier based on the first schedule;
generating, at the computing device, a modified target profile corresponding to one of the target identifiers selected based on the utilization metrics, the modified target profile including a modified value for the target attribute; and
generating, at the computing device, a second schedule based on the modified target profile.

2. The method of claim 1, wherein each shift record of the first plurality of shift records defines a time period, a task identifier, and a portion of the time period corresponding to the task identifier; and
wherein generating the utilization metric for each target identifier is based on a sum of the time periods associated with the target identifier.

3. The method of claim 1, further comprising:
comparing the utilization metrics to a threshold; wherein the selected target identifier is less than the threshold.

4. The method of claim 1—further comprising:
determining a first efficiency metric for the first schedule, and a second efficiency metric for the second schedule; and
deploying the second schedule when the second efficiency metric exceeds the first efficiency metric.

5. The method of claim 1, further comprising:
controlling a display to present the second schedule, and a visual indicator associated with a shift record associated with the target identifier selected based on the utilization metrics.

6. The method of claim 1, wherein generating the modified target profile includes retrieving configuration data defining the modified value.

7. The method of claim 1, further comprising:
determining, at the computing device, a residual time period corresponding to the first schedule;
generating a synthetic target profile based on the residual time period; and
generating the second schedule based on the modified target profile and the synthetic target profile.

8. The method of claim 7, wherein generating the synthetic target profile includes generating a synthetic target identifier, and duplicating a reference value corresponding to one of the target profiles.

9. A computing device, comprising:
a memory; and
a processor configured to:
retrieve a plurality of target profiles, each target profile including a target identifier and a reference value for a target attribute;
generate based on the plurality of target profiles, a first schedule including a first plurality of shift records, each shift record of the first plurality of shift records including one of the target identifiers;
determine a utilization metric for each target identifier based on the first schedule;
generate a modified target profile corresponding to one of the target identifiers selected based on the utilization metrics, the modified target profile including a modified value for the target attribute; and
generate a second schedule based on the modified target profile.

10. The computing device of claim 9, wherein each shift record of the first plurality of shift records defines a time period, a task identifier, and a portion of the time period corresponding to the task identifier; and
wherein the processor is configured to generate the utilization metric for each target identifier based on a sum of the time periods associated with the target identifier.

11. The computing device of claim 9, wherein the processor is further configured to:
compare the utilization metrics to a threshold; wherein the selected target identifier is less than the threshold.

12. The computing device of claim 9, wherein the processor is further configured to:
determine a first efficiency metric for the first schedule, and a second efficiency metric for the second schedule; and
deploy the second schedule when the second efficiency metric exceeds the first efficiency metric.

13. The computing device of claim 9, wherein the processor is further configured to:
control a display to present the second schedule, and a visual indicator associated with a shift record associated with the target identifier selected based on the utilization metrics.

14. The computing device of claim 9, wherein the processor is configured to generate the modified target profile by retrieving configuration data defining the modified value.

15. The computing device of claim 9, wherein the processor is further configured to:
determine, at the computing device, a residual time period corresponding to the first schedule;
generate a synthetic target profile based on the residual time period; and
generate the second schedule based on the modified target profile and the synthetic target profile.

16. The computing device of claim 15, wherein the processor is further configured to generate the synthetic target profile by generating a synthetic target identifier, and duplicating a reference value corresponding to one of the target profiles.
